(19) United States
(12) Patent Application Publication
(10) Pub. No.: US 2010/0052837 A1
(43) Pub. Date: Mar. 4, 2010

(54) Integrated Circuit Multilevel Inductor

(76) Inventor: Siqi Fan, San Diego, CA (US)

Correspondence Address: LAW OFFICE OF GERALD MALISZEWSKI, P.O. BOX 270829, SAN DIEGO, CA, 92198-2829, US

(21) Appl. No.: 12/203,163

(22) Filed: Sep. 3, 2008

(51) Int. Cl. H01F 5/00

(52) U.S. Cl. 336/200

(57) ABSTRACT

An integrated circuit (IC) multilevel inductor structure is provided. The IC multilayer inductor structure is made from an IC including a plurality of circuit layers, where the inductor is a three-dimensional (3D) loop formed over a plurality of the circuit layers. In a simple example, if the IC includes a first circuit layer and a second circuit layer, then the inductor 3D loop includes a first partial loop portion formed on the first circuit layer, a second partial loop portion formed on the second circuit layer, and a via connecting the first and second partial loop portions. More generally, the inductor typically includes a plurality of 3D loops. A first plurality of 3D loops is formed between the input and an nth circuit layer, and a second plurality of 3D loops is formed between the nth circuit layer and the output.

### BACKGROUND OF THE INVENTION

1. Field of the Invention

This invention generally relates to integrated circuit (IC) fabrication and, more particularly, to a multilayer inductor suitable for IC applications.

2. Description of the Related Art

Conventional digital systems fabricated on a single printed circuit board (PCB) or a collection of connected PCBs still often require analog circuitry. For example, analog circuits are often used in active buffers to boost a signal between communication nodes, or as an oscillator to create a reference signal. In both applications, inductors are used to peak or tune the signal to a desired frequency. The problem is that inductors tend to be large bulky components, and the electrical performance of bigger inductors (with higher quality (Q) factors and lower loss) is generally more desirable. The use of large inductors on PCBs results in higher costs, greater assembly complications, and a larger overall package size.

It is difficult to fabricate inductors integrally to a PCB. An inherent capacitance develops between metal in different interlevels of the PCB, especially at higher frequencies, and vias between interlevel traces have a relatively large resistance.

It would be advantageous if a PCB-style inductor could be designed, especially for use in analog circuits with low Q resonance requirements.

### SUMMARY OF THE INVENTION

The present invention IC multilayer inductor permits inductor cores to be eliminated from designs, producing more dies per wafer, and generally reducing fabrication and assembly costs. The IC multilayer can be used in signal tuning/peaking inductors and voltage-control oscillator tank applications, where the area size is limited and the quality factor requirement is not as strict. By constructing an inductor using metal evenly distributed between layers, “metal density” manufacturing design rules are met.

Accordingly, an integrated circuit (IC) multilevel inductor structure is provided. The IC multilayer inductor structure is made from an IC including a plurality of circuit layers, where the inductor is a three-dimensional (3D) loop formed over a plurality of the circuit layers. In a simple example, if the IC includes a first circuit layer and second circuit layer, then the inductor 3D loop includes a first partial loop portion formed on the first circuit layer, a second partial loop portion formed on the second circuit layer, and a via connecting the first and second partial loop portions.

More generally, the inductor typically includes a plurality of 3D loops. An input on the first circuit layer is connected to a partial loop portion of a first 3D loop. An output on the kth circuit layer is connected to a partial loop portion of a second 3D loop. A first plurality of 3D loops is formed between the input and an nth circuit layer, and a second plurality of 3D loops is formed between the nth circuit layer and the output.

Additional details of the above-described IC multilayer inductor are presented below.

### BRIEF DESCRIPTION OF THE DRAWINGS

FIGS. 1A and 1B are perspective and plan views, respectively, depicting an integrated circuit (IC) multilevel inductor structure.

FIGS. 2A and 2B are related perspective views showing an inductor structure, where the inductor includes a plurality of 3D loops.

FIG. 3 is a plan view of a variation of the IC multilayer inductor structure including inner and outer cores.

FIG. 4 is a perspective drawing depicting the use of inner and outer cores across two circuit layers.

FIGS. 5A through 5N are plan view depicting the routing of 3D loops between overlying circuit layers.

### DETAILED DESCRIPTION

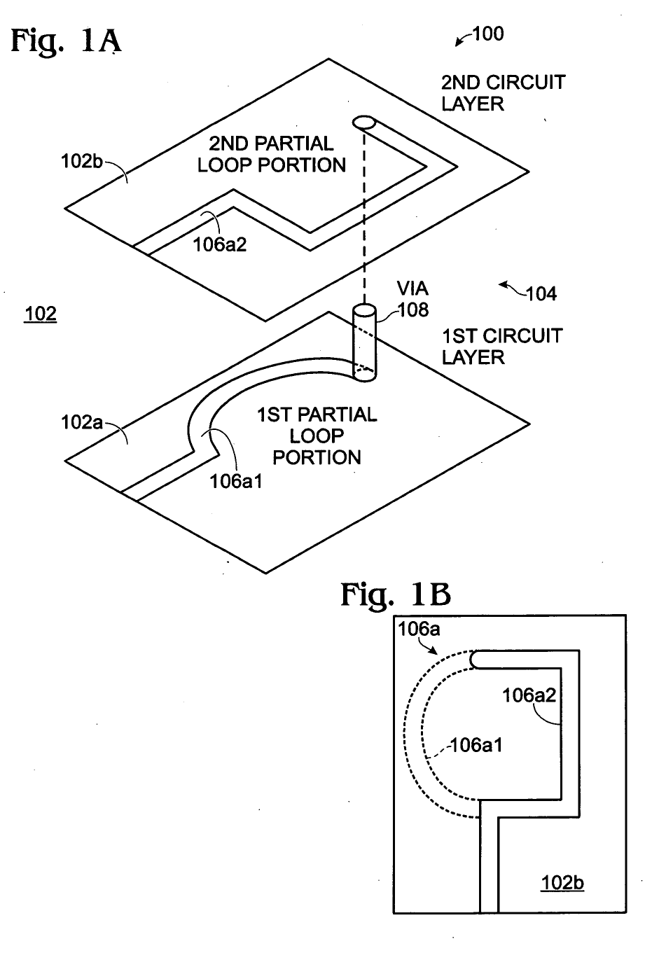

FIGS. 1A and 1B are perspective and plan views, respectively, depicting an integrated circuit (IC) multilevel inductor structure. The inductor structure 100 comprises an IC 102 including a plurality of circuit layers. First circuit layer 102a and second circuit layer 102b are shown. It should be understood that the IC typically includes other features on layers 102a and 102b, not shown, as well as additional circuit layers or interlevels (not shown). Typically, a dielectric material (not shown), such as silicon oxide, is interposed between circuit layers. An inductor 104 including a three-dimensional (3D) loop 106a is formed over a plurality of the circuit layers. More explicitly, the inductor 3D loop 106a includes a first partial loop portion 106a1 formed on the first circuit layer 102a, and second partial loop portion 106a2 formed on the second circuit layer 102b. A via 108 connects the first partial loop portion 106a1 and second partial loop portion 106a2.

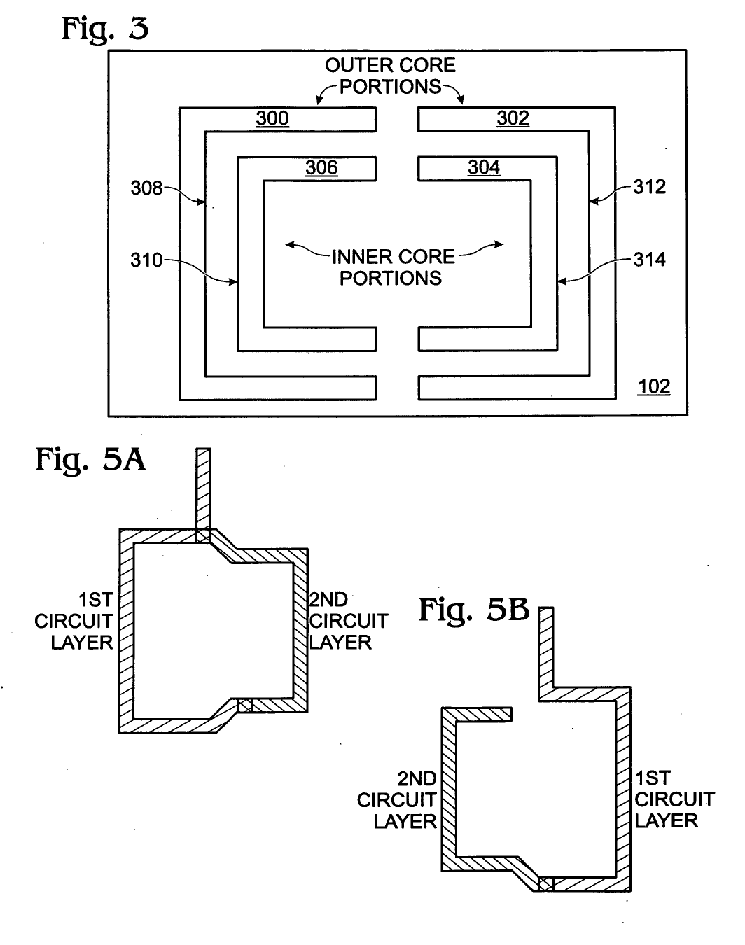

As viewed from above in superposition (FIG. 1B), it can be seen that the two partial loops form a complete loop structure. In the aspect shown, second partial loop portion 106a1 has a rectangular shape, and the first partial loop portion 106a2 has a circular shape. It should be understood that loop is not limited to any particular shape or combination of shapes. Some exemplary shapes include circular, square, rectangular, oval, hexagonal, and octagonal. In other aspects (see FIG. 3), each partial loop portion has substantially the same shape.

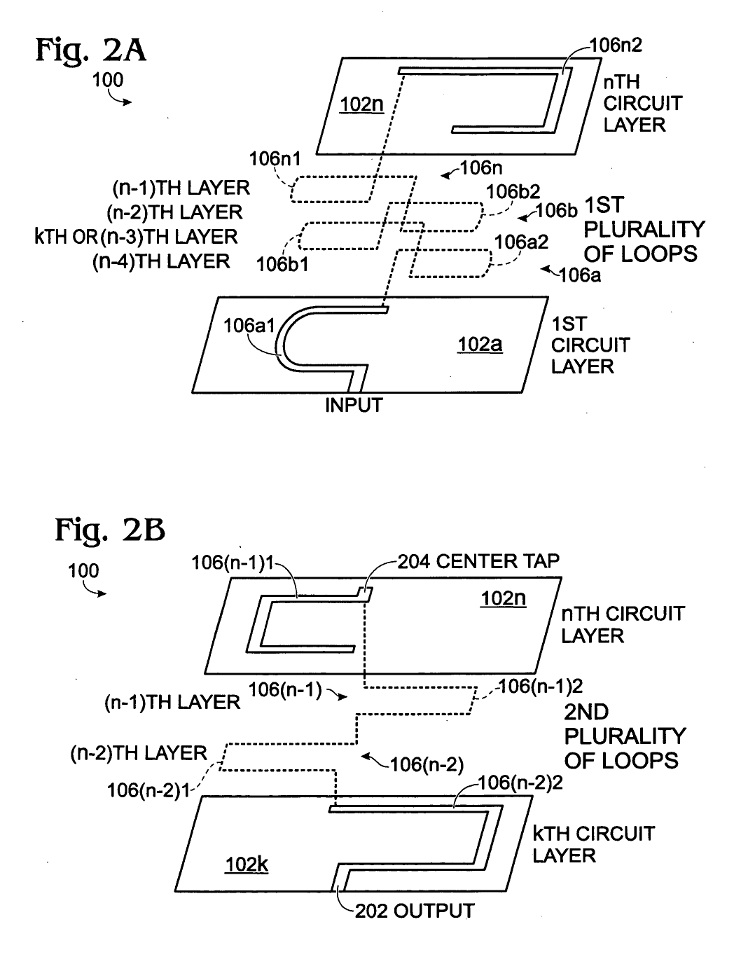

FIGS. 2A and 2B are related perspective views showing an inductor structure, where the inductor includes a plurality of 3D loops. The inductor includes an input 200 on the first circuit layer 102a connected to a partial loop portion 106a1 of a first 3D loop 106a, see FIG. 2A. An output (via) on the kth circuit layer (see FIG. 2B) is connected to a partial loop portion 106(n-2) 2 of a second 3D loop 106(n-2). Generally, a first plurality (n/2) of 3D loops is formed between the input 200 and an nth circuit layer 102n, where n is not limited to any particular number. Shown are loop 106b, with partial loop portions 106b1 and 106b2, and loop 106n, with partial loop portions 106n1 and 106n2. For clarity, only the first circuit layer 102a and nth circuit layer 102n are shown in FIG. 2A, with the partial loop portions between layer 102a and 102n shown in phantom.

Likewise, a second plurality of 3D loops is formed between the nth circuit layer 102n and the output 202 on the kth circuit layer 102k, which could also be represented as the (n-3)th circuit layer in this aspect (see in FIG. 2B). Shown are 3D loops 106(n-1) and 106(n-2). For clarity, only circuit layer 102n and 102k are shown in FIG. 2B, with the partial loop portions between layer 102n and 102k shown in phantom.

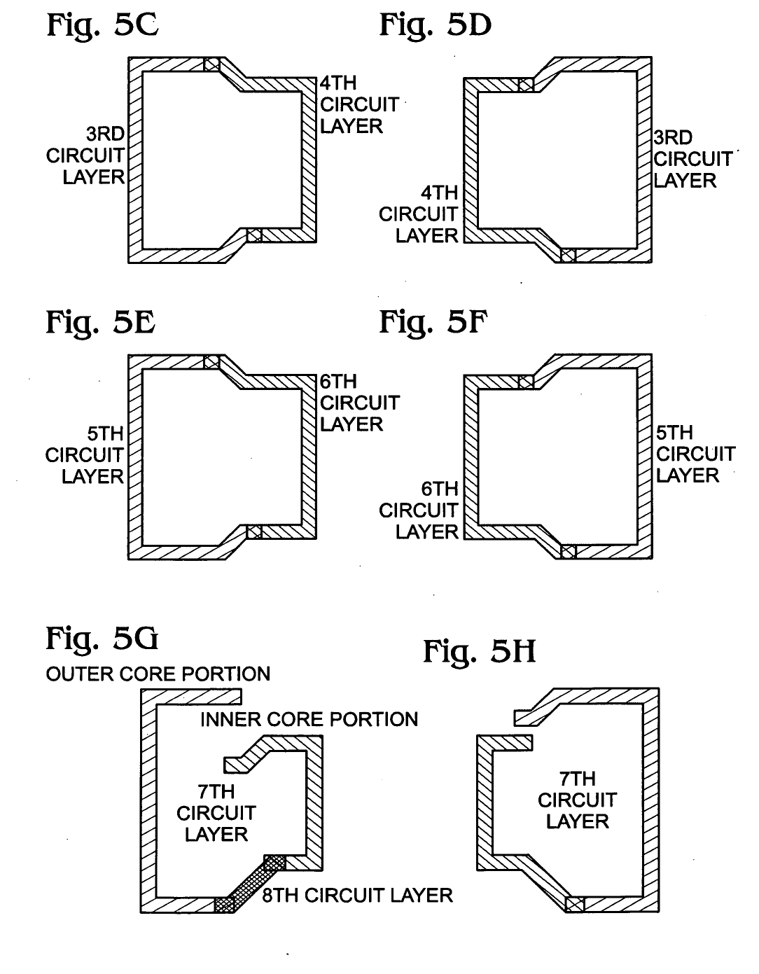

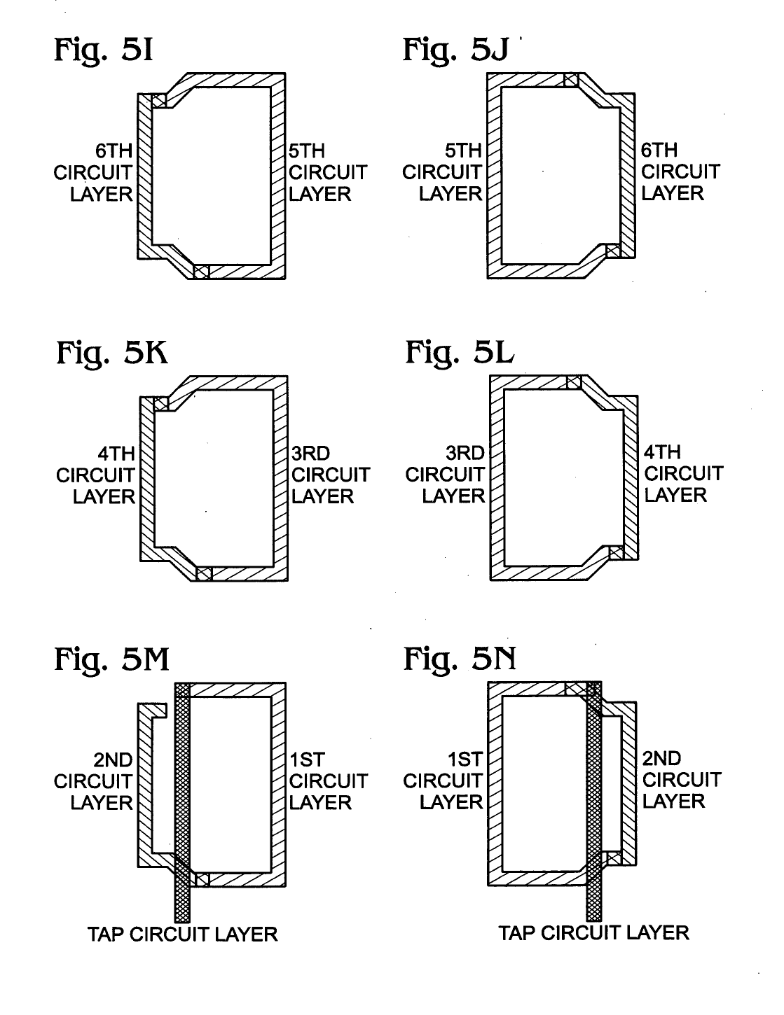

As shown, the input 200 and output 202 are on different circuit layers. That is, the first plurality of 3D loops includes more loops than the second plurality of 3D loops. In other aspects, the input 200 and output 202 are on the same circuit layer, and the first plurality of 3D loops equals the second plurality of 3D loops. In other aspects, (see FIGS. 5A-5N), an odd number of circuit layers is used.

In one aspect, the inductor structure 100 further comprises a center tap 204 on the nth circuit layer 102n connected to partial loop portion 106(n-1)1 of 3D loop 106(n-1).

FIG. 3 is a plan view of a variation of the IC multilayer inductor structure including inner and outer cores. Shown are four partial loop portions on a single circuit layer 102, where each partial loop portion is associated with a different 3D loop. Referring briefly to FIGS. 2A and 2B, the first plurality of 3D loops are formed (ascending) between circuit layer 102a and 102n, while the second plurality of 3D loops are formed (descending) between circuit layers 102n and 102k. Continuing the protocol established in FIGS. 2A and 2B, outer core portion 300 may be a partial loop portion from the first plurality of 3D loops, while outer core portion 302 may be from the second plurality of 3D loops.

The first outer core portion inside edge 308 is adjacent the second inner core portion outer edge 310 on each circuit layer. Likewise, the second outer core portion inside edge 312 is adjacent the first inner core portion outside edge 314 on each circuit layer.

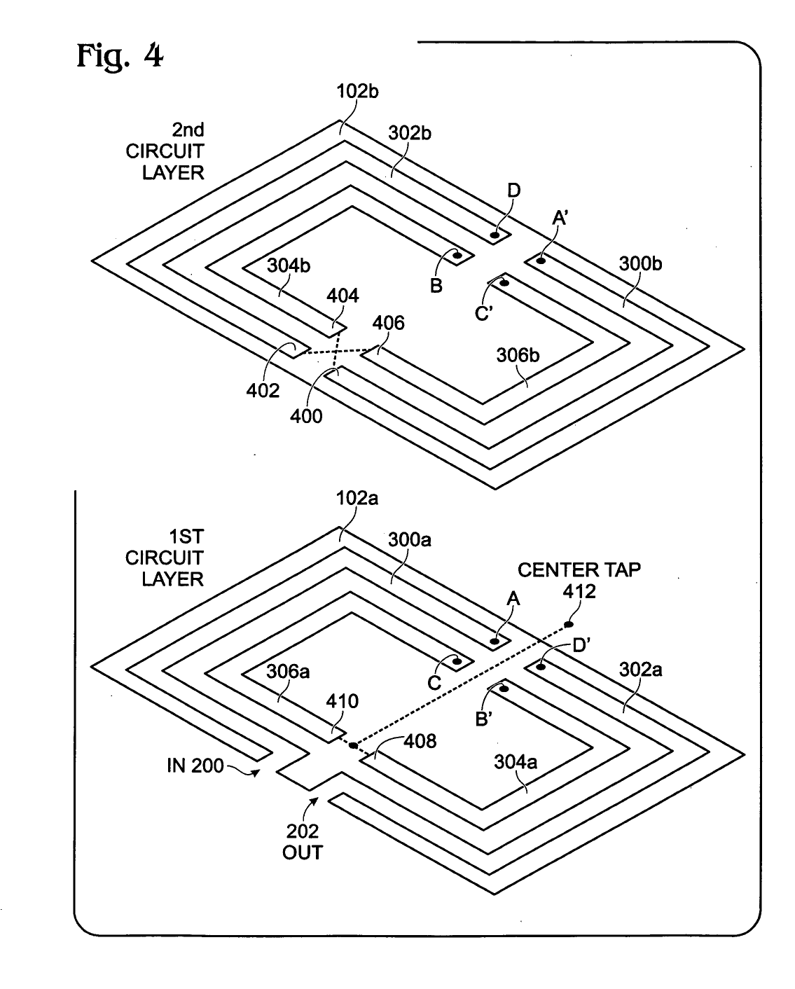

FIG. 4 is a perspective drawing depicting the use of inner and outer cores across two circuit layers. For simplicity and clarity, the first plurality of 3D loops is being represented by one 3D loop in this example. Likewise, the second plurality of 3D loops is being represented by a single 3D loop. The first plurality of 3D loops forms a first outer core portion 300 on each circuit layer. First outer core portion 300a is formed on circuit layer 102a and first outer core portion 300b is formed on circuit layer 102b. The connection between outer core portions is made by an interlevel interconnected or via (not shown) between nodes A and A′. Outer core portions 300a and 300b are part of the same 3D loop. Likewise, the second plurality of 3D loops forms a second outer core portion 302 on each circuit layer. Second outer core portion 302a is formed on circuit layer 102a and second outer core portion 302b is formed on circuit layer 102b, connecting between nodes D and D′ with a via (not shown). Outer core portions 302a and 302b are part of the same 3D loop.

The first plurality of 3D loops has a termination node 400 on the nth circuit layer. In this aspect, the nth circuit layer is the second circuit layer 102b. The second plurality of 3D loops has a termination node 402 on the nth circuit layer 102b. A third plurality of 3D loops has a first termination node 404 connected to the termination node 400 of the first plurality of 3D loops on the nth circuit layer 102b. The connection between nodes is shown with a dotted line. The third plurality of 3D loops forms a first inner core portion on each circuit layer. Shown are first inner core portion 304a on circuit layer 102a and first inner core portion 304b on circuit layer 102b. Again, for simplicity, the third plurality of 3D loops has been represented by a single 3D loop. Inner core portions 304a and 304b are connected between C and C′ with an unseen via.

A fourth plurality of 3D loops have a first termination node 406 connected to the termination node 402 of the second plurality of 3D loops on the nth circuit layer 102b. The connection between nodes is shown with a dotted line. The fourth plurality of 3D loops forms a second inner core portion on each circuit layer. Shown are second inner core portion 306a on circuit layer 102a and second inner core portion 306b on circuit layer 102b. Again, for simplicity, the fourth plurality of 3D loops has been represented by a single 3D loop. Inner core portions 306a and 306b are connected between B and B′ with an unseen via.

The third plurality of 3D loops has a second termination node 408 on the kth circuit layer. In this aspect, since the input 200 and the output 202 of the inductor are on the same circuit layer (layer 102a), the kth circuit layer is the first circuit layer. See FIGS. 2A and 2B for an example of the first and kth circuit layers being different circuit layers. The fourth plurality of 3D loops has a second termination node 410 on the kth circuit layer 102a, connected to the second termination node 408 of the third plurality of 3D loops. The connection between nodes is shown with a dotted line.

In one aspect as shown, a center tap 412 is connected to the second termination node of either the third or fourth plurality of 3D loops. It should be understood that the inductor does not require a center tap.

In another aspect not shown, the first plurality of 3D loops ascends via first outer loop portions, but the third plurality of 3D loops descends via second outer loop portions. Then, the third plurality of 3D loops ascends via first inner loop portions and the fourth plurality of 3D loops descends, or is connected to the output, via second inner loop portions.

### Functional Description

The inductor structure of FIG. 4 may alternately be considered as having two differential inputs on the first (lowest) layer metal. Each input path stays on the first metal layer for a half turn and then moves to adjacent upper layer through 45 degree metal bridges and a connecting via. The process is repeated until the nth (top) metal layer is reached. Thus, the first core (2 turns) is completed. Then, connecting bridges are used to jump through the core into the inner space. The same routing from nth layer to the first layer is used to construct the second core (2 turns). A center tap may be connected to the geometrical center of outer core. The structure is symmetrical by construction.

FIGS. 5A through 5N are plan view depicting the routing of 3D loops between overlying circuit layers. FIG. 5A shows an ascending 3D loop comprised of outer core portions, one of the first plurality of 3D loops, formed on the first and second circuit layers. FIG. 5B shows a descending 3D comprised of outer core portions, one of the second plurality of 3D loops, formed on the second and first circuit layers. FIG. 5C shows an ascending 3D loop comprised of outer core portions, one of the first plurality of 3D loops, formed on the third and fourth circuit layers. FIG. 5D shows a descending 3D comprised of outer core portions, one of the second plurality of 3D loops, formed on the fourth and third circuit layers. FIG. 5E shows an ascending 3D loop comprised of outer core portions, one of the first plurality of 3D loops, formed on the fifth and sixth circuit layers. FIG. 5F shows a descending 3D comprised of outer core portions, one of the second plurality of 3D loops, formed on the sixth and fifth circuit layers. FIG. 5G shows one of the first plurality of loops formed on the seventh circuit layer, where a portion of the loop is formed from an outer core section, and a portion is form an inner core portion. Alternately considered, the first and third plurality of 3D loops may be said to both include a partial loop (i.e. 3 full loops and one partial loop). This loop asymmetry exists because an odd number of circuit layers are used. Likewise, FIG. 5H shows one of the second plurality of loops formed on the seventh circuit layer, where a portion of the loop is formed from an outer core section, and a portion is form an inner core portion. Alternately considered, the second and fourth pluralities of 3D loops both include a partial loop (i.e. 3 full loops and one partial loop).

FIG. 5I shows a descending 3D loop comprised of inner core portions, one of the third plurality of 3D loops, formed on the sixth and fifth circuit layers. FIG. 5J shows an ascending 3D loop comprised of inner core portions, one of the fourth plurality of 3D loops, formed on the fifth and sixth circuit layers. FIG. 5K shows a descending 3D loop comprised of inner core portions, one of the third plurality of 3D loops, formed on the fourth and third circuit layers. FIG. 5L shows an ascending 3D loop comprised of inner core portions, one of the fourth plurality of 3D loops, formed on the third and fourth circuit layers. FIG. 5M shows a descending 3D loop comprised of inner core portions, one of the third plurality of 3D loops, formed on the second and first circuit layers. Also shown is a center tap. FIG. 5N shows an ascending 3D loop comprised of inner core portions, one of the fourth plurality of 3D loops, formed on the first and second circuit layers.

An IC multilayer inductor has been provided. Examples using specific number of circuit layers and routing paths have been given to illustrate the invention. However, the invention is not limited to just these examples. Further, although the 3D loops have been described as comprising half-portions, it should be understood that the 3D loops can be portioned into a greater number of sections, located on a greater number of circuit layers. Other variations and embodiments of the invention will occur to those skilled in the art.

We claim:

1. An integrated circuit (IC) multilevel inductor structure comprising:
an IC including a plurality of circuit layers;
an inductor including a three-dimensional (3D) loop formed over a plurality of the circuit layers.

2. The inductor structure of claim 1 wherein the IC includes a first circuit layer and second circuit layer; and,
wherein the inductor 3D loop includes:
a first partial loop portion formed on the first circuit layer;
a second partial loop portion formed on the second circuit layer; and,
a via connecting the first and second partial loop portions.

3. The inductor structure of claim 2 wherein the inductor includes a plurality of 3D loops.

4. The inductor structure of claim 3 wherein the inductor includes:
an input on the first circuit layer connected to a partial loop portion of a first 3D loop;
an output on the kth circuit layer connected to a partial loop portion of a second 3D loop;
a first plurality of 3D loops formed between the input and an nth circuit layer; and,
a second plurality of 3D loops formed between the nth circuit layer and the output.

5. The inductor structure of claim 4 wherein the first and kth circuit layers are the same layer, and wherein the first plurality of 3D loops equals the second plurality of 3D loops.

6. The inductor structure of claim 5 further comprising:
a center tap on the nth circuit layer connected to a partial loop portion of a 3D loop.

7. The inductor structure of claim 4 wherein the first plurality of 3D loops form a first outer core portion on each circuit layer, and,
wherein the second plurality of 3D loops form a second outer core portion on each circuit layer.

8. The inductor structure of claim 7 wherein the first plurality of 3D loops have a termination node on the nth circuit layer;
wherein the second plurality of 3D loops have a termination node on the nth circuit layer;
wherein the inductor further includes:
a third plurality of 3D loops having a first termination node connected to the termination node of the first plurality of 3D loops on the nth circuit layer, the third plurality of 3D loops forming a first inner core portion on each circuit layer; and,
a fourth plurality of 3D loops having a first termination node connected to the termination node of the second plurality of 3D loops on the nth circuit layer, the fourth plurality of 3D loops forming a second inner core portion on each circuit layer.

9. The inductor structure of claim 8 wherein the third plurality of 3D loops have a second termination node on the kth circuit layer; and,
wherein the fourth plurality of 3D loops have a second termination node on the kth circuit layer, connected to the second termination node of the third plurality of 3D loops.

10. The inductor structure of claim 9 wherein a first outer core portion inside edge is adjacent a second inner core portion outer edge on each circuit layer; and,
wherein a second outer core portion inside edge is adjacent a first inner core portion outside edge on each circuit layer.

11. The inductor structure of claim 10 wherein a first outer core portion on the first circuit layer is connected to a second outer core portion, through a via, on a second circuit layer overlying the first circuit layer; and,
wherein a first inner core portion on the first circuit layer is connected to a second inner core portion, through a via, on the second circuit layer.

12. The inductor structure of claim 9 further comprising:
a center tap connected to the second termination node of the third plurality of 3D loops.

13. The inductor structure of claim 1 wherein the inductor 3D loop has a plan perspective shape selected from a group consisting of circular, square, rectangular, oval, hexagonal, and octagonal.
